(19) United States
(12) Patent Application Publication
(10) Pub. No.: US 2019/0366764 A1
(43) Pub. Date: Dec. 5, 2019

(54) VEHICLE WHEEL

(71) Applicant: HONDA MOTOR CO., LTD., Tokyo (JP)

(72) Inventors: Kenichi NAGATOMI, Wako-shi (JP); Toshimitsu MAKI, Wako-shi (JP); Ryoji INABA, Wako-shi (JP)

(21) Appl. No.: 16/426,168

(22) Filed: May 30, 2019

(30) Foreign Application Priority Data
May 31, 2018 (JP) 2018-105657

(51) Int. Cl. B60B 21/12; B60C 19/00; B60B 21/02

(52) U.S. Cl. CPC B60B 21/12; B60C 19/002; B60B 2900/133; B60B 21/023; B60B 21/026

(57) ABSTRACT

A vehicle wheel includes a rim having an outer circumferential wall on a tire air chamber and a Helmholtz resonator having an auxiliary air chamber. The Helmholtz resonator is disposed in a space on an inner circumferential side of a bead sheet and the auxiliary air chamber is in communication with the tire air chamber through a through-hole penetrating through the rim.

### CROSS REFERENCE TO RELATED APPLICATION

This application claims priority of Japan patent application No. 2018-105657, filed on May 31, 2018, the entire content of which is incorporated herein by reference.

### FIELD OF THE INVENTION

The invention relates to a vehicle wheel.

### BACKGROUND OF THE INVENTION

When a vehicle is travelling, the air in a tire air chamber is vibrated by the vibration transmitted from the road surface. When the frequency of the air matches the natural frequency of the tire air chamber, pipe resonance is generated and then makes noise. Therefore, a vehicle wheel disclosed in JP2008-279873A comprises a Helmholtz resonator disposed at an outer circumference side of a well portion and suppresses the noise made by the pipe resonance.

The Helmholtz resonator disclosed in JP2008-279873A has an attachment configuration in which a vertical wall is formed at an outer side of the well portion extending outwardly in a wheel radial direction and the Helmholtz resonator is disposed between the vertical wall and a side wall of the well portion. Circumferential grooves are formed by cutting, in a wheel circumferential direction, side surfaces of the vertical wall and of the side wall, and edge portions of the Helmholtz resonator engage with the circumferential grooves.

### DESCRIPTION OF THE RELATED ART

JP2008-279873A discloses the vehicle wheel to which the Helmholtz resonator is attached as described above.

### SUMMARY OF THE INVENTION

The circumferential grooves are not easily formed (by cutting the side surfaces of the vertical wall and the side wall in the wheel circumferential direction), and therefore there is demand for a vehicle wheel which does not need circumferential grooves.

It is an object of the invention is to provide a vehicle wheel that does not need the circumferential grooves.

To achieve the object described above, a vehicle wheel according to the present invention comprises a rim having an outer circumferential wall on a tire air chamber and a Helmholtz resonator having an auxiliary air chamber, wherein the Helmholtz resonator is disposed in a space on an inner circumference side of a bead sheet of the rim and the auxiliary air chamber is in communication with the tire air chamber through a through-hole penetrating through the rim.

According to the present invention, a vehicle wheel that does not need circumferential grooves can be provided.

### BRIEF DESCRIPTION OF THE DRAWINGS

The invention will now be described with reference of the following drawings.

FIG. 1 A schematic sectional view when a vehicle wheel of an embodiment is cut along a plane extending in the vertical direction and beyond the rotation axis of the wheel and viewed from a rear side.

FIG. 2 An end view of an enlarged vicinity of a vehicle body side inner circumference space illustrated in FIG. 1.

FIG. 3 A side view of a portion which is a part of the vehicle wheel and a Helmholtz resonator is attached to when viewed from an inner side in a vehicle width direction.

FIG. 4 An end view when the portion of the vehicle wheel illustrated in FIG. 3 is cut along the IV-IV plane.

FIG. 5 A schematic sectional view when a vehicle wheel of a first modification is cut along a plane extending in the vertical direction and viewed from a rear side.

FIG. 6 A side view of a vehicle wheel of a second modification when viewed from an outer side in the vehicle width direction.

FIG. 7 An end view when the vehicle wheel illustrated in FIG. 6 is cut along the VII-VII plane.

Next, embodiments of a vehicle wheel of the present invention will be explained with reference to the drawings. The basic configuration of the vehicle wheel will be explained first, and then a characteristic configuration of the vehicle wheel will be explained. A left one of right and left vehicle wheels will be referred to while explaining the embodiments of and the basic configuration of the vehicle wheel.

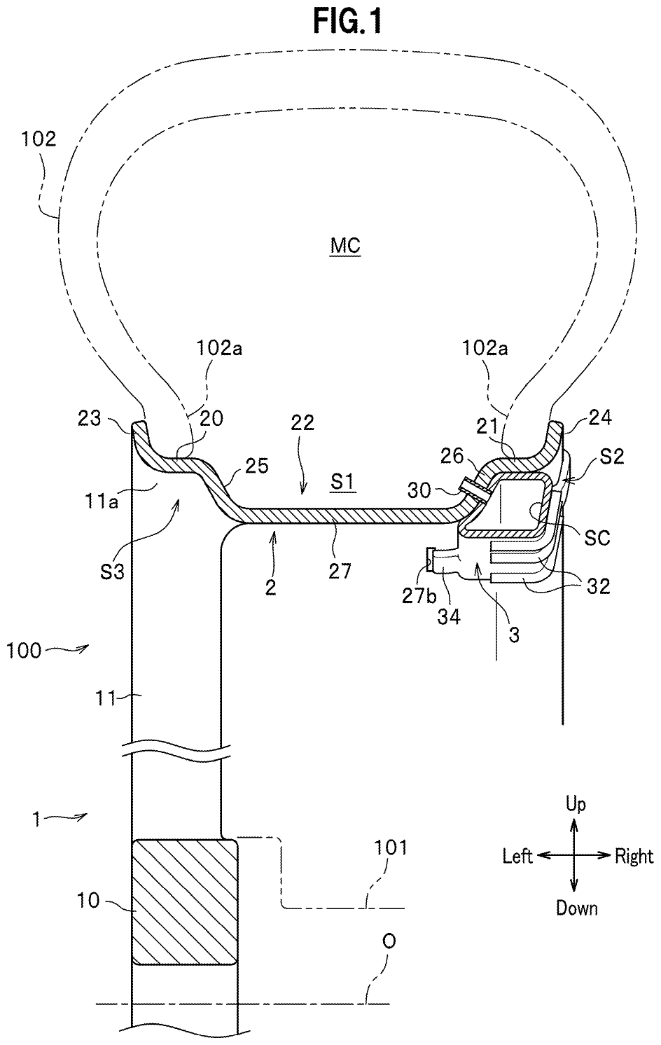

As shown in FIG. 1, a vehicle wheel 100 is fixed to an axle hub 101 with (unillustrated) bolts and rotates about a rotation axis O with a tire 102 attached to the outer circumference side of the vehicle wheel 100. Hereinafter, the rotation axis O is simply referred to as an axis O.

The vehicle wheel 100 includes a substantially disc-shaped disc 1 fixed to the axle hub 101, a substantially cylindrical rim 2 to which the tire 102 is attached, and a Helmholtz resonator 3.

The disc 1 of and the rim 2 of this embodiment may, for example, be made of such a lightweight high-strength material as an aluminum alloy, a magnesium alloy, or the like, and may be integrally formed as a one-piece wheel. The present invention is not limited to the one-piece wheel and may be a two-piece wheel or a three-piece wheel.

The disc 1 is a spoke-type disc. The disc 1 thus comprises a wheel hub 10 positioned at the center of the disc 1 and fastened to the axle hub 101, and a plurality of spokes 11 extending outwardly from an outer circumferential surface of the wheel hub 10 in a wheel radial direction. An end portion 11a at an outer side of each spoke 11 in the wheel radial direction extends continuously from an outer part, in a vehicle width direction, of an inner circumferential surface of the rim 2.

The rim 2 comprises a pair of bead sheets 20, 21 that supporting bead portions 102a, 102a of the tire 102, a well portion 22 positioned between a pair of the bead sheets 20, 21 and having a recess S1 at an outer circumferential side of the well portion 22, and a pair of rim flanges 23, 24 extending outwardly from the bead sheets 20, 21 in the wheel radial direction

The bead sheets 20, 21 support the bead portions 102a, 102a of the tire 102 in the wheel radial direction. The bead sheets 20, 21 have cylindrical shapes circulating around the axis O, and a length of each of the bead sheets 20, 21 in a direction of the axis O is relatively short and the bead portions 102a, 102a of the tire 102 contact the outer circumferential surfaces of the bead sheets 20, 21.

Hereinafter, regarding a pair of the bead sheets 20, 21, the one formed at an outer side of the rim 2 relative to the well portion 22 in the vehicle width direction is referred to as an outer bead sheet 20, and the one formed at an inner side of the rim 2 relative to the well portion 22 in the vehicle width direction is referred to as an inner bead sheet 21.

The well portion 22 has a pair of side walls 25, 26 which have annular shapes and extend inwardly from end portions of a pair of the bead sheets 20, 21 in the wheel radial direction, and a bottom wall 27 which has a cylindrical shape and extends continuously from inner ends, in the wheel radial direction, of a pair of the side walls 25, 26. That is, the well portion 22 has a substantially U-shaped cross-section and has the recess S1 at the outer circumferential side. The recess S1 of the well portion 22 is a part of a tire air chamber MC and is a space to which the bead portions 102a, 102a of the tire 102 are dropped when the tire 102 is attached to the rim 2.

A pair of the side walls 25, 26 of this embodiment are inclined inwardly in the vehicle width direction as a pair of the side walls 25, 26 extend inwardly in the wheel radial direction.

Hereinafter, regarding a pair of the side walls 25, 26, the one extending continuously from a right end (an inner end in the vehicle width direction) of the outer bead sheet 20 is referred to as an outer side wall 25, and the one extending continuously from a left end (an outer end in the vehicle width direction) of the inner bead sheet 21 is called an inner side wall 26.

A pair of the rim flanges 23, 24 prevent bead portions 102a, 102a of the tire 102 from coming off from the bead sheets 20, 21.

Hereinafter, regarding a pair of the rim flanges 23, 24, the one extending continuously from a left end (an outer end in the vehicle width direction) of the outer bead sheet 20 is referred to as an outer rim flange 23, and the one extending continuously from a right end (an inner end in the vehicle width direction) of the inner bead sheet 21 is referred to as an inner rim flange 24.

According to the above-mentioned configuration, an inner circumferential side of the tire air chamber MC is closed by the rim 2, which results in the tire air chamber MC having a sealed space. The rim 2 has a space on an inner circumferential side of each of the bead sheets 20, 21 and both of the inner spaces are positioned apart from each other in the direction of the axis O. Hereinafter, the space positioned on the inner circumferential side of the inner bead sheet 21 is referred to as a vehicle body side inner circumferential space S2, and the space positioned on the inner circumferential side of the outer bead sheet 20 is referred to as a disc side inner circumferential space S3.

The Helmholtz resonator 3 has a substantially rectangular cross-section and is a hollow member which is made of a resin and has an inner space functioning as an auxiliary air chamber SC. The Helmholtz resonator 3 is provided with a tube 30 through which the auxiliary air chamber SC is in communication with the tire air chamber MC. Details of the Helmholtz resonator 3 will be described later. Next, the characteristic configuration of the vehicle wheel 100 will be explained.

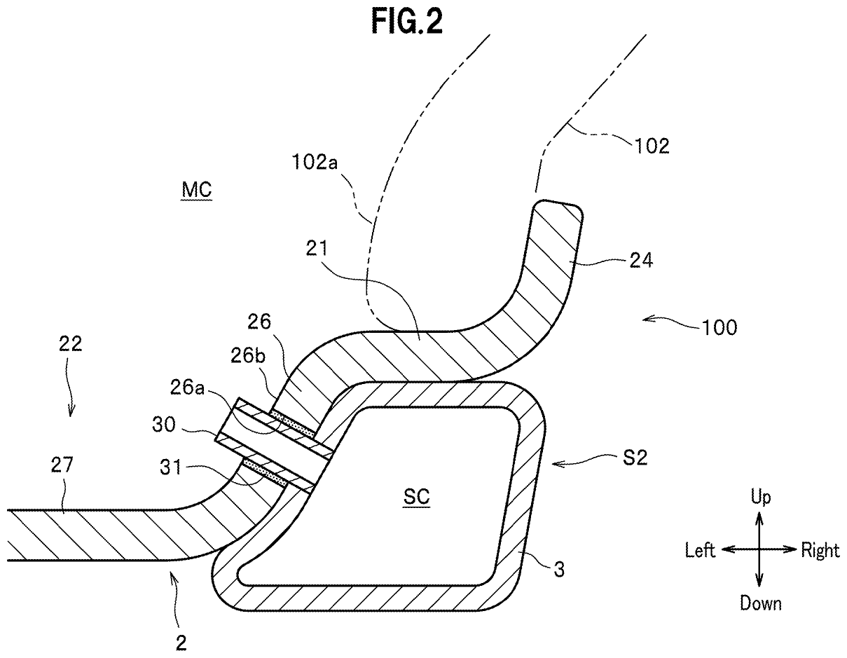

As shown in FIG. 2, the vehicle wheel 100 of this embodiment comprises the rim 2 having an inner circumferential wall of the tire air chamber MC and the Helmholtz resonator 3 having the auxiliary air chamber SC. The Helmholtz resonator 3 is disposed in the space (the vehicle body side inner circumferential space S2) on the inner circumferential side of the inner bead sheet 21 of the rim 2, and the auxiliary air chamber SC is in communication with the tire air chamber MC through a through-hole 26a penetrating through the rim 2.

According to the above-mentioned configuration, the vehicle wheel 100 does not comprise a conventional vertical wall extending upward from an outer circumferential surface of the well portion 22 and conventional grooves formed by cutting side surfaces of the vertical wall and either of the side walls 25, 26, which results in the vehicle wheel 100 being easily manufactured.

When centrifugal force is applied to the Helmholtz resonator 3, the Helmholtz resonator 3 is supported by the inner bead sheet 21 positioned at an outer circumferential side of the Helmholtz resonator 3. Therefore, the Helmholtz resonator 3 has high fixing strength.

The Helmholtz resonator 3 is not disposed in the tire air chamber MC. That is, even after the tire 102 is attached to the vehicle wheel 100, the Helmholtz resonator 3 can be attached to the vehicle wheel 100. Therefore, the Helmholtz resonator 3 can be easily attached to the vehicle wheel 100.

The Helmholtz resonator 3 is disposed outside the tire air chamber MC and the configuration of the Helmholtz resonator 3 does not affect the pipe resonance.

The Helmholtz resonator 3 is disposed in the space (the vehicle body side inner circumferential space S2) on the inner circumferential side of the inner bead sheet 21 and the disc 1 is disposed outwardly in the vehicle width direction relative to the Helmholtz resonator 3. Therefore, the Helmholtz resonator 3 is prevented from being exposed to the ultraviolet and from being hit by small stones thrown up by any of other cars, which results in the Helmholtz resonator 3 having high long-term resistance. Moreover, since the Helmholtz resonator 3 is hardly visible, the appearance of the vehicle wheel 100 is not affected.

The through-hole 26a is bored through the inner side wall 26 of the well portion 22. A seal member 31 made of a rubber is disposed between an inner circumferential surface of the through hole 26a and an outer circumferential surface of the tube 30. Therefore, the tire air chamber MC is securely sealed and the tube 30 is prevented from falling off from the through-hole 26a. The seal member 31 of this embodiment is made of a rubber, but may be made of a resin.

The tube 30 protrudes from an inner circumferential surface 26b of the inner side wall 26 into the tire air chamber MC. That is, the tube 30 protrudes from the inner circumferential surface of the rim 2 into the tire air chamber MC. Therefore, even when a water and a puncture repair agent in the tire air chamber MC are moved along the inner circumferential surface 26b of the inner side wall 26, the water and the puncture repair agent hardly flow into the tube 30.

The tube 30 is inclined to have one end portion in the tire air chamber positioned outwardly in the wheel radial direction relative to the other end portion at the side of the auxiliary air chamber SC. Even when a puncture repair agent or the like flows into the auxiliary air chamber SC through the tube 30, the puncture repair agent or the like in the auxiliary air chamber SC is easily discharged back into the tire air chamber MC through the tube 30 by centrifugal force occurring while the vehicle is travelling. As described above, the configuration of the embodiment prevents a puncture repair agent from remaining in the auxiliary air chamber SC, which results in the volume of the auxiliary air chamber SC hardly decreasing.

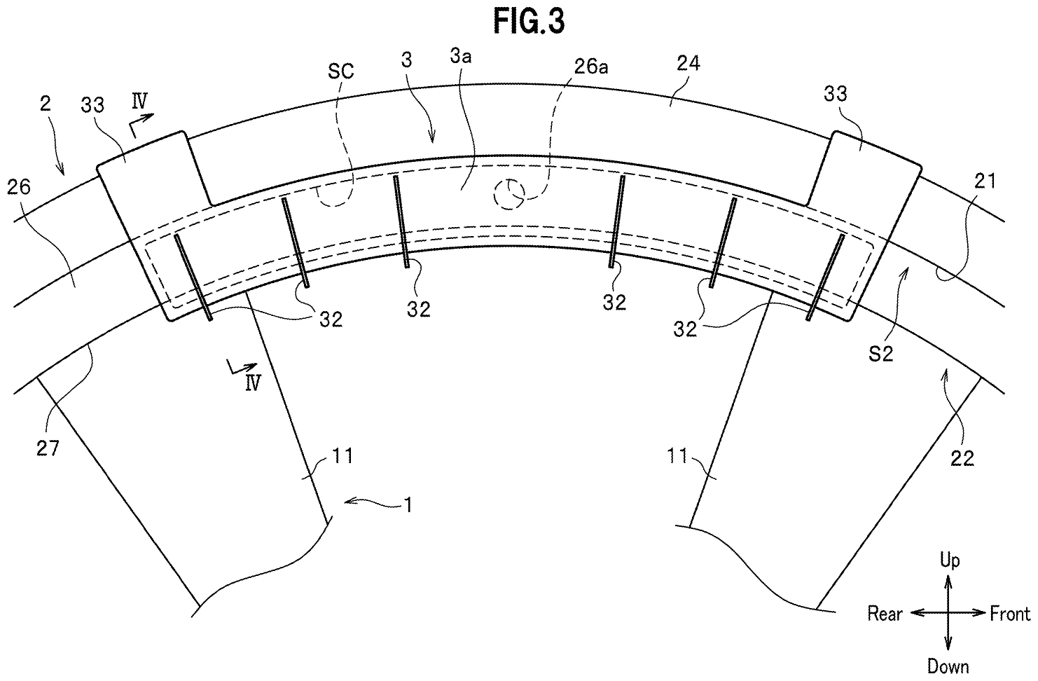

As shown in FIG. 3, the Helmholtz resonator 3 has an arc shape and extends along the vehicle body side inner circumferential space S2 when viewed from a lateral side of the Helmholtz resonator 3. Therefore, the auxiliary air chamber SC also extends in a wheel circumferential direction, and a predetermined volume of the sub air chamber SC is ensured.

A length of the Helmholtz resonator 3 of the present invention in the wheel circumferential direction is not particularly limited and can be determined arbitrarily. Four Helmholtz resonators 3 are disposed in the vehicle body side inner circumferential space S2 of the vehicle wheel 100 at intervals of 90 degrees, which is not illustrated in the drawings.

Ribs 32 are provided on an outer surface 3a of the Helmholtz resonator 3. A plurality of ribs 32 are provided apart from each other in the wheel circumferential direction.

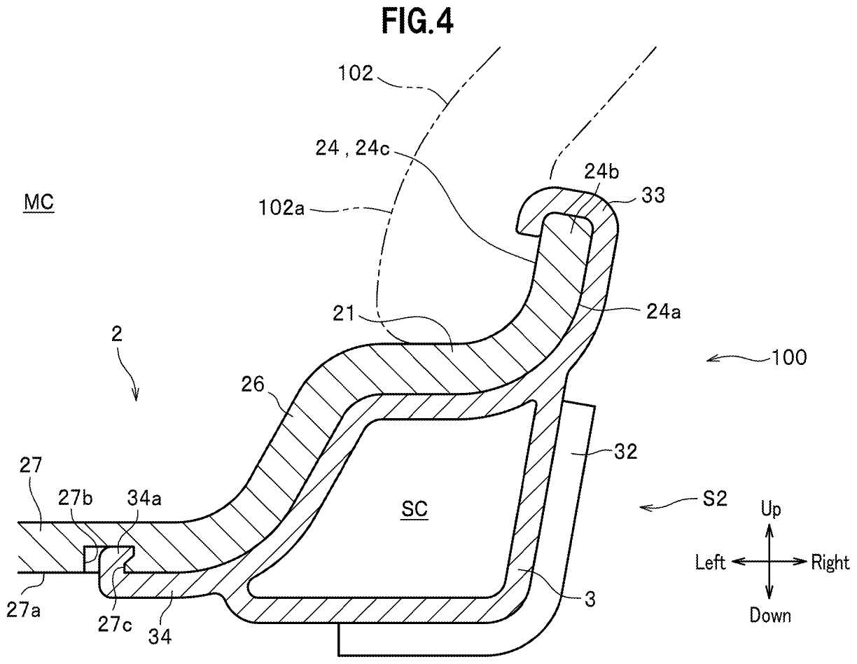

As shown in FIG. 4, each of the ribs 32 has a substantially L-shape when viewed from a front-rear direction of the ribs 32 and extends along from a portion, facing inwardly in the vehicle width direction, of the outer surface 3a of the Helmholtz resonator 3 to a portion, facing inwardly in the wheel radial direction, of the outer surface 3a of the Helmholtz resonator 3.

Remaining portions (a portion facing outwardly in the vehicle width direction and a portion facing outwardly in the wheel radial direction) of the outer surface 3a of the Helmholtz resonator 3 are supported by the rim 2 (the inner side wall 26 and the inner bead sheet 21).

Therefore, the Helmholtz resonator 3 is not deformed by the internal pressure of the auxiliary air chamber SC.

The rim 2 has the inner rim flange 24 extending outwardly from the right end of the inner bead sheet 21 in the wheel radial direction. The Helmholtz resonator 3 has an outward engaging portion 33 having a substantially J-shaped cross-section. The outward engaging portion 33 extends outwardly in the wheel radial direction and hooks to the inner rim flange 24. The Helmholtz resonator 3 has outward engaging portions 33, 33 at opposite ends in the wheel radial direction (as referred to FIG. 3).

According to the above-mentioned configuration, the Helmholtz resonator 3 engages with the rim 2 inwardly in the wheel radial direction, which results in the resonator being prevented from falling off from the rim 2 and having high fixing strength.

When the Helmholtz resonator 3 is attached to the rim 2, if the Helmholtz resonator 3 is disposed in the vehicle body side inner circumferential space S2 which hooking the outward engaging portions 33, 33 to the inner rim flange 24, the position of the tube 30 is kept constant in the wheel radial direction and as a result the tube 30 is easily inserted into the through-hole 26a. Therefore, the outward engaging portion 33 also serves to position the tube 30 relative to the through-hole 26a when inserting the tube 3 into the through-hole 26a.

The outward engaging portion 33 will be described in detail. As shown in FIG. 4, the outward engaging portion 33 extends outwardly from an upper portion of the Helmholtz resonator 3 in the wheel radial direction and along a right surface (an outer surface facing inwardly in the vehicle width direction) 24a of the inner rim flange 24. A distal end portion 33a of the outward engaging portion 33 is curved leftwardly and downwardly along a distal end portion 24b, and contacts a left surface (an inner surface facing outwardly in the vehicle width direction) 24c of the inner rim flange 24.

The distal end portion 33a of the outward engaging portion 33 only engages with a portion, positioned outwardly in the wheel radial direction, of the left surface 24c of the inner rim flange 24, and the portion engaged with the distal end portion 33a is relatively short in the wheel radial direction. Therefore, even after the tire 102 is attached to the bead sheets 20, 21, the distal end portion 33a of the outward engaging portion 33 can engage with the inner rim flange 24 and the sealing performance of the tire air chamber MC is not affected.

An engaged portion 27b is formed by recessing an inner circumferential surface 27a of the bottom wall 27 of the well portion 22 outwardly in the wheel radial direction. A claw 27c extending outwardly in the vehicle width direction and abutting the engaged portion 27b is formed at the bottom wall 27. The Helmholtz resonator 3 has an axial-direction engaging portion 34 extending in the axial direction (outwardly in the vehicle width direction) and hooking to the engaged portion 27b (the claw 27c).

The axial-direction engaging portion 34 will be explained in detail. The axial-direction engaging portion 34 extends outwardly in the vehicle width direction from a wall portion, positioned outwardly in the vehicle width direction, of the Helmholtz resonator 3 and along the inner circumferential surface 27a of the bottom wall 27. A distal end portion 34a of the axial-direction engaging portion 34 is curved outwardly in the wheel radial direction, enters into the engaged portion 27b, and engages with the claw 27c inwardly in the wheel radial direction. As described above, the Helmholtz resonator 3 engages with the rim 2 inwardly in the vehicle width direction, which results in the Helmholtz resonator 3 being prevented from falling off from the rim 2 and having high fixing strength.

The Helmholtz resonator 3 has axial-direction engaging portions 34 at opposite ends in the wheel circumferential direction, which is not illustrated in the drawings.

The engaged portion 27b is formed to correspond to the axial-direction engaging portion 34. That is, as shown in FIG. 1, the engaged portion 27b is only formed by recessing a part of the inner circumferential surface 27a of the bottom wall 27 and does not extend in the wheel circumferential direction.

Although the embodiment has been explained above, the present invention is not limited to the example embodiment.

Regarding a method to fix the Helmholtz resonator 3 to the vehicle wheel 100, the Helmholtz resonator 3 of this embodiment is fixed to the rim 2 through the outward engaging portions 33 and the axial-direction engaging portions 34, but the present invention is not limited thereto.

For example, an extending portion extending along the inner circumferential surface 27a of the bottom wall 27 may be formed instead of the axial-direction engaging portion 34, and the extending portion may be fixed to the bottom wall 27 by adhesion.

An extending portion extending along the right surface (outer surface) 24a of the inner rim flange 24 may be formed instead of the outward engaging portion 33, and the extending portion may be fixed to the inner rim flange 24 by adhesion.

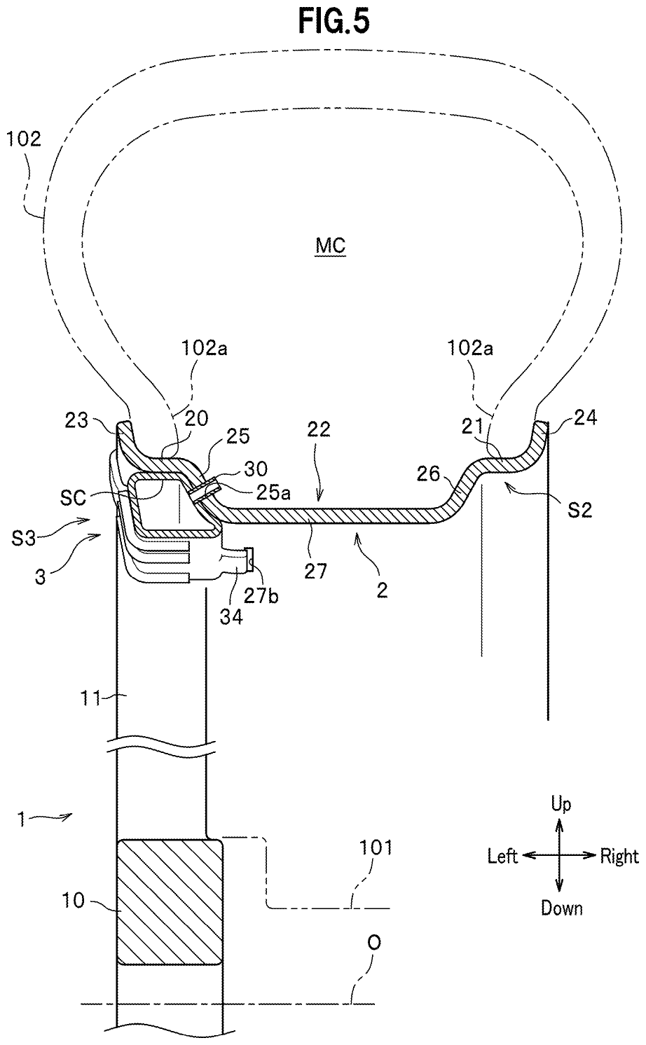

The Helmholtz resonator 3 of this embodiment is disposed in the vehicle body side inner circumferential space S2, but according to the present invention, the Helmholtz resonator 3 may be disposed in the space on the inner circumference side of the outer bead sheet 20 (the disc side inner circumferential space S3) as shown in FIG. 5.

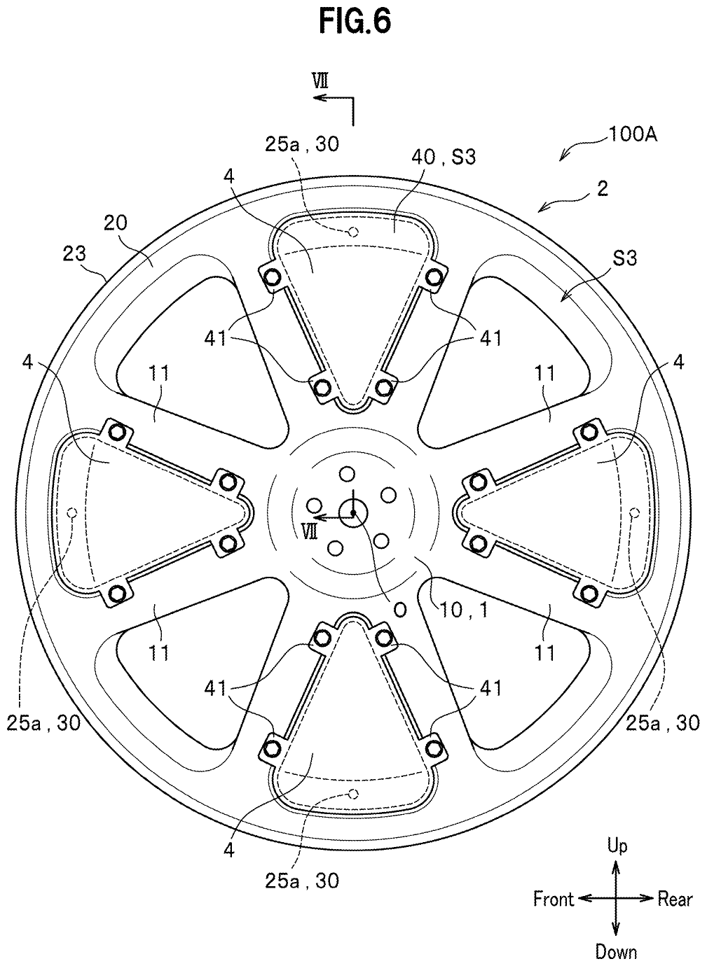

In this case, the disc side inner circumferential space S3 is partitioned in the wheel circumferential direction by a plurality of spokes 11 (as referred to FIG. 6). For this reason, when the Helmholtz resonator 3 is disposed in the disc side inner circumferential space S3, the Helmholtz resonator 3 is preferable to be disposed such that an end portion, in the wheel circumferential direction, of the Helmholtz resonator 3 contacts the spoke 11. According to this configuration, the Helmholtz resonator 3 is prevented from being displaced in the wheel circumferential direction and the fixing strength of the Helmholtz resonator 3 is improved. According to this example modification, the through-hole 25a is bored through the outer side wall 25 of the well portion 22.

According to the present invention, among a plurality of Helmholtz resonators 3, some of the Helmholtz resonators 3 may be disposed in the vehicle body side inner circumferential space S2, and the rests of the Helmholtz resonators 3 may be disposed in the disc side inner circumferential space S3. The through-hole 26a is not limited to be formed by boring through the outer side wall 25 or the inner side wall 26 and may be formed by boring through the bottom wall 27.

The Helmholtz resonators 3 of the embodiment and of the above-mentioned example modification have arc shapes and extend along the inner circumferential space (the vehicle body side inner circumferential space S2 and the disc side inner circumferential space S3) when viewed from lateral sides of the Helmholtz resonators 3. In other words, the Helmholtz resonators 3 have shapes such that the substantially whole Helmholtz resonators 3 are disposed in the inner circumferential space (the vehicle body side inner circumferential space S2 and the disc side inner circumferential space S3).

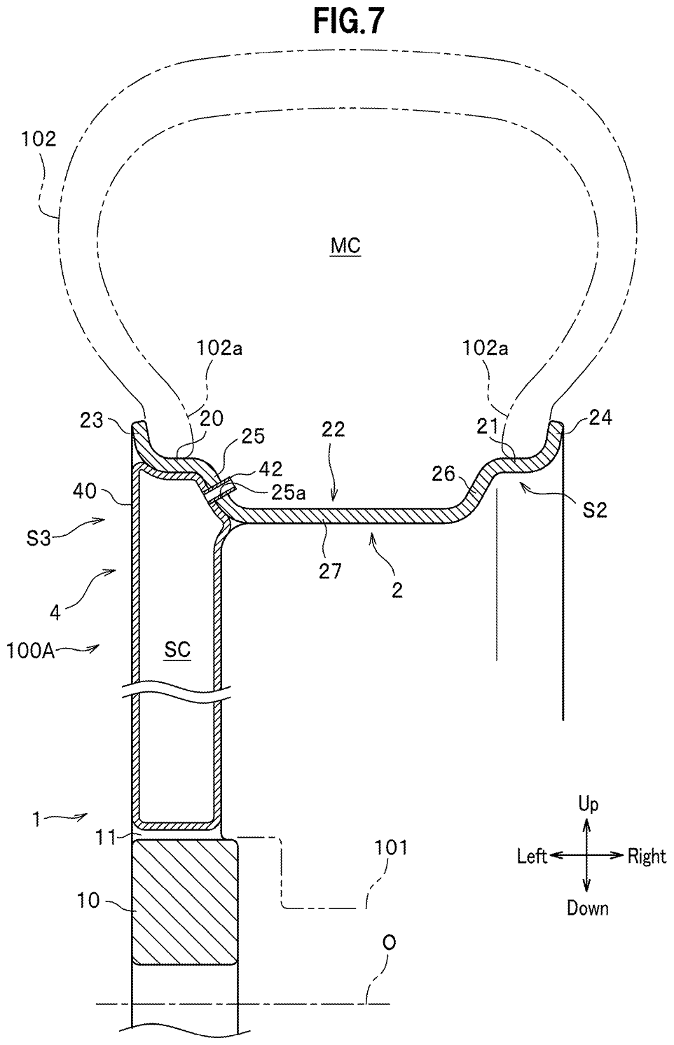

However, the Helmholtz resonator of the present invention is not limited to have the arc shape. That is, the present invention is not particularly limited as long as the Helmholtz resonator has a shape such that the Helmholtz resonator can be disposed in spaces on the inner circumference sides of a pair of the bead sheets 20, 21. Hereinafter, a Helmholtz resonator according to the example modification will be explained with reference to FIGS. 6 and 7.

As shown in FIG. 6, a Helmholtz resonator 4 according to the example modification has a fan shape when viewed from a lateral side of the Helmholtz resonator 4. The Helmholtz resonator 4 is disposed between the spokes 11, 11 of the disc 1, and an outer circumferential portion 40 of the Helmholtz resonator 4 is positioned in the disc side inner circumferential space S3.

The Helmholtz resonator 4 has attachment portions 41 extending outwardly in the wheel circumferential direction. The attachment portions 41 are fixed to the adjacent spokes 11 by bolts, which results in the Helmholtz resonator 4 being fixed to the disc 1.

According to the example modification, four Helmholtz resonators 4 are disposed at intervals of 90 degrees in the wheel circumferential direction and are attached to the vehicle wheel 100A.

As shown in FIG. 7, a tube 42 is provided at the outer circumferential portion 40 of the Helmholtz resonator 4. The tube 42 is inserted through the through-hole 25a bored through the outer side wall 25, which results in the auxiliary air chamber SC being in communication with the tire air chamber MC through the tube 42.

A length of the Helmholtz resonator 4 in the wheel radial direction is almost the same as a length of the spoke 11 in the wheel radial direction and is greater than a length of the arc-shaped Helmholtz resonator 3 in the wheel radial direction (as referred to FIG. 1) of the above embodiment, which has been explained. That is, the volume of the auxiliary air chamber SC formed in the Helmholtz resonator 4 is also greater than the volume of the auxiliary air chamber SC of the arc-shaped Helmholtz resonator 3 of the above embodiment, which has been explained.

As described above, the present invention is not limited to the arc-shaped Helmholtz resonator 3, and the Helmholtz resonator 4 having the auxiliary air chamber SC with a great volume which can effectively suppress noise may be used.

A (unillustrated) brake caliper is disposed at an inner side, in the wheel radial direction, of the vehicle body side inner circumferential space S2. For this reason, when using the Helmholtz resonator 4 expanding in the wheel radial direction, the Helmholtz resonator 4 needs to be disposed at the disc side inner circumferential space S3.

It is understood that the foregoing description is that of the preferred embodiments of the invention and that various changes and modifications may be made thereto without departing from the spirit and scope of the invention as defined in the appended claims.

What is claimed is:

1. A vehicle wheel comprising:
a rim having an outer circumferential wall on a tire air chamber; and,
a Helmholtz resonator having an auxiliary air chamber;
wherein the Helmholtz resonator is disposed in a space on an inner circumferential side of a bead sheet of the rim; and,
wherein the auxiliary air chamber is in communication with the tire air chamber through a through-hole penetrating through the rim.

2. The vehicle wheel of claim 1, wherein:
the rim has a rim flange extending outwardly from the bead sheet in a wheel radial direction; and,
the Helmholtz resonator has an outward engaging portion extending outwardly in the wheel radial direction and hooking to the rim flange.

3. The vehicle wheel of claim 1, wherein :
the bead sheet is an inner bead sheet positioned inwardly in a vehicle width direction relative to a well portion of the rim; and,
the Helmholtz resonator is disposed in the space on the inner circumferential side of the inner bead sheet.

4. The vehicle wheel of claim 1, wherein:
the bead sheet is an outer bead sheet positioned outwardly in a vehicle width direction relative to a well portion of the rim; and,
the Helmholtz resonator is disposed in the space on the side of the inner circumferential side of the outer bead sheet.

5. The vehicle wheel of claim 1, wherein:
a tube of the Helmholtz resonator is inclined such that one tube end portion in the tire air chamber is positioned outwardly in a wheel radial direction relative to the other tube end portion at the side of the auxiliary air chamber.

6. The vehicle wheel of claim 1, wherein:
an engaged portion is formed by recessing an inner circumferential surface of a well portion outwardly in a wheel radial direction; and,
the Helmholtz resonator has an axial-direction engaging portion extending in a direction of the wheel rotation axis and hooking to the engaged portion.

7. The vehicle wheel of claim 1, wherein:
a tube of the Helmholtz resonator protrudes through an inner circumferential surface of the rim into the tire air chamber.

8. The vehicle wheel of claim 1, wherein:
a rib is provided on an outer surface of the Helmholtz resonator.
